(19) United States
(12) Patent Application Publication
(10) Pub. No.: US 2026/0186226 A1
(43) Pub. Date: Jul. 2, 2026

(54) MODULAR FIBER OPTIC CONNECTIVITY SYSTEM WITH SLIDING SERVICEABLE CONNECTOR MODULES

(71) Applicants: George Wakileh, Batavia, IL (US); Alexander George Wakileh, Batavia, IL (US)

(72) Inventors: George Wakileh, Batavia, IL (US); Alexander George Wakileh, Batavia, IL (US)

(21) Appl. No.: 19/438,476

(22) Filed: Dec. 31, 2025

Related U.S. Application Data
(60) Provisional application No. 63/740,846, filed on Dec. 31, 2024.

(51) Int. Cl. G02B 6/44

(52) U.S. Cl. CPC G02B 6/44528; G02B 6/4454

(57) ABSTRACT

A modular fiber optic connectivity system for optical signal management with scalable expansion and serviceability is disclosed. The system includes a distribution housing defining a fiber management interior and containing factory pre-routed and pre-loaded optical fiber assemblies organized in standardized groupings. Sliding connector modules are mounted within the distribution housing and are movable between service and installed positions to permit installation, replacement, or maintenance of optical components without rerouting feeder fibers. In certain embodiments, one or more modular cassette assemblies are receivable within the distribution housing and support internal fiber management structures, connector interface regions, and optical subcomponents, including sliding connector modules. Splitter modules are supported by the sliding connector modules, and multifiber ports are configured to support pass-through optical signals and distribution outputs. The system enables incremental expansion from a first operational capacity to a larger operational capacity without disturbing installed fibers or replacing feeder cables.

### RELATED PATENT APPLICATION

The present U.S. Non-Provisional, Utility U.S. Patent Application claims priority under 35 U.S.C. § 119(e) to U.S. Provisional Patent Application No. 63/740,846, Confirmation No. 5705, tiled CATALYST FIBER OPTIC CONNECTIVITY CENTER, filed with the USPTO on Dec. 31, 2024, the subject matter of which is incorporated herein by reference.

### FIELD OF THE INVENTION

The present invention falls within the field of telecommunications, specifically focusing on fiber optic communication systems and optical networking hardware.

### BACKGROUND OF THE INVENTION

Fiber optic communication networks continue to expand rapidly to meet increasing demand for high-speed data services, cloud computing, video streaming, and fiber-to-the-home (FTTH) deployments. As network capacity requirements increase, service providers require fiber management systems capable of supporting higher connection densities while maintaining reliability, serviceability, and efficient use of physical space.

Conventional fiber optic distribution systems, including optical distribution frames and fiber hubs, often rely on fixed or semi-fixed architectures that limit scalability and complicate maintenance. Many existing systems lack modular internal sub-assemblies that can be inserted, removed, or reconfigured independently within a common housing. As a result, expanding capacity or servicing optical components frequently requires rerouting feeder fibers, disturbing installed connections, or performing extensive field cable management. Such operations increase installation time, raise the risk of service disruption, and add operational cost.

High-density fiber environments further exacerbate these issues. As connector counts increase, internal cable congestion, excess fiber slack, and limited access to connectors can make provisioning, testing, and repair more difficult. In many existing systems, connector modules are not movable between distinct service and installed positions, requiring technicians to remove or manipulate adjacent components to access a target connection. This increases the likelihood of accidental disconnections, signal degradation, or damage to neighboring fibers.

Additionally, existing fiber distribution solutions are frequently optimized for a single deployment environment. Systems designed for aerial or pedestal installations may not be well suited for below-grade deployment, where exposure to moisture, flooding, and limited access conditions impose additional design constraints. In many cases, accommodating different deployment environments requires entirely different hardware platforms rather than a unified, adaptable system architecture.

Accordingly, there remains a need for a fiber optic connectivity system that provides high-density capacity while enabling incremental expansion, simplified maintenance, and serviceability without rerouting feeder fibers or disturbing installed connections. There is also a need for such a system to support multiple deployment configurations, including below-grade installations, while maintaining reliable access to optical components and minimizing service interruptions.

### SUMMARY OF THE INVENTION

The following is intended to be a brief summary of the invention and is not intended to limit the scope of the invention:

The present invention relates to a modular fiber optic connectivity system configured to support high-density optical networks while enabling scalable capacity expansion, simplified maintenance, and enhanced serviceability. The system is particularly suited for applications requiring incremental growth and reliable access to optical components without rerouting feeder fibers, disturbing installed connections, or interrupting existing service.

In one aspect, the invention comprises a distribution housing defining a high-density fiber management interior. The distribution housing contains a plurality of factory pre-routed and pre-loaded optical fiber assemblies organized in standardized groupings of optical fibers. A plurality of sliding connector modules are mounted within the distribution housing, each sliding connector module being movable between a service position and an installed position. The sliding connector modules permit installation, removal, replacement, and maintenance of optical components while adjacent modules remain installed, and without rerouting feeder fibers or redistributing installed fibers.

In another aspect, one or more high-density splitter modules are supported by the sliding connector modules. At least one multifiber port is configured to simultaneously support pass-through optical signals and distribution outputs from the splitter modules, thereby enabling integration of pass-through and distribution functionality within a common modular architecture. System capacity is incrementally expandable by selective insertion of additional sliding connector modules, allowing expansion from a first operational capacity to a larger operational capacity without replacement of feeder cables.

In a further aspect, the invention includes a modular cassette assembly receivable within the distribution housing. The modular cassette assembly comprises a cassette housing supporting internal fiber management structures and one or more connector interface regions. The cassette assembly may further support sliding connector modules and optical functional modules, and may include a removable cassette cover to provide access to internal components. The modular cassette assembly enables scalable capacity expansion and serviceability through modular insertion, removal, or reconfiguration of optical subcomponents within the distribution housing.

In certain implementations, one or more modular cassette assemblies are configured for insertion into a fiber distribution enclosure that receives, aligns, and retains the cassette assemblies while managing incoming, outgoing, and pass-through optical fibers.

In an additional aspect, the distribution housing may include a physically separate pass-through side configured to maintain craft separation between feeder fibers and distribution fibers. The distribution housing may further be configured as a flood-resistant enclosure suitable for below-grade installation, while also supporting alternative deployment configurations including pole-mounted and pedestal-mounted installations without modification to the internal fiber architecture.

Through the combination of factory pre-routed fiber assemblies, sliding serviceable connector modules, modular cassette assemblies, and flexible enclosure-based deployment, the present invention reduces installation complexity, minimizes service disruption, and provides a compact, reliable, and scalable solution for modern high-density fiber optic connectivity systems.

### BRIEF DESCRIPTION OF THE DRAWINGS

The components shown in the drawings are not to scale. In the interest of clarity, some of the components might be shown in a generalized form and could be identified utilizing commercial designations. All components, including its essential features, have been assigned reference numbers that are utilized consistently throughout the descriptive process outlined herein:

FIG. 1 illustrates an example modular fiber optic connectivity system showing a distribution housing, factory pre-routed optical fibers, sliding connector modules, pass-through fibers, and distribution outputs.

FIG. 2 illustrates a high-density optical splitter module configured for use within the modular fiber optic connectivity system.

FIG. 3 illustrates an example configuration in which pass-through optical signals and distribution outputs coexist within a common modular architecture.

FIG. 4 illustrates a multipurpose signal-carrying module including an optical splitter component, a multifiber port, standardized fiber groupings, and a pass-through interface.

FIG. 5 illustrates an example deployment view of the modular fiber optic connectivity system showing feeder fibers, pass-through fibers, and distribution outputs.

FIG. 6 illustrates an overall view of the modular fiber optic connectivity system in an example installation environment.

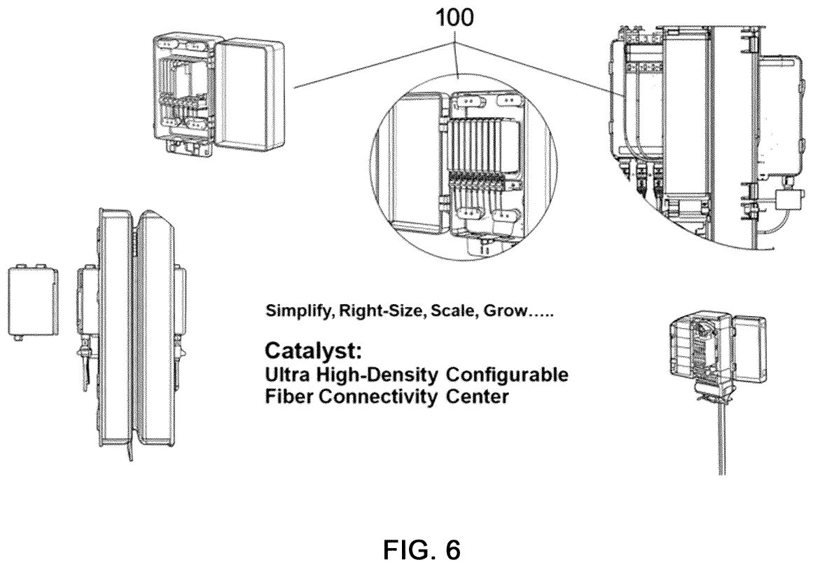

FIG. 7 illustrates example pre-loaded, factory-configured embodiments of a modular fiber distribution system.

FIG. 8 illustrates example capacity and configuration concepts for scalable deployment of the modular fiber optic connectivity system.

FIG. 9 illustrates example internal components including fiber routing elements and multifiber interfaces within a module of the system.

FIG. 10 illustrates an example below-grade deployment configuration including a physically separate pass-through side of a fiber distribution enclosure.

FIG. 11 illustrates an example ultra high-density splitter module configuration.

FIG. 12 illustrates example multifiber connector arrangements for use with the modular fiber optic connectivity system.

FIG. 13 illustrates example insertion loss measurement results associated with fiber optic components of the system.

FIG. 14 illustrates example insertion loss and return loss test data associated with fiber optic components of the system.

FIG. 15 illustrates an example system-level deployment configuration showing coexistence of multiple optical functions.

FIG. 16 illustrates example mounting and deployment configurations including wall-mounted, pedestal-mounted, and pole-mounted installations.

FIG. 17 illustrates an example modular cassette assembly including a cassette housing, internal fiber management structures, connector interface regions, and removable subcomponents.

FIG. 18 illustrates an exploded view of a modular cassette assembly showing internal components and assembly relationships.

FIG. 19 illustrates an assembled view of the modular cassette assembly with internal components visible.

FIG. 20 illustrates a fiber distribution enclosure configured to receive and align a plurality of modular cassette assemblies for managing incoming, outgoing, and pass-through optical fibers.

### FIGURE REFERENCE NUMBERS

100—Modular Fiber Optic Connectivity System. The complete modular, scalable fiber optic connectivity system as claimed and illustrated.
101—Distribution Housing. A structural enclosure defining a high-density fiber management interior for supporting optical components and modules.
102—High-Density Fiber Management Interior. The internal space of the distribution housing configured to receive fiber assemblies, sliding connector modules, and splitter modules.
103—Factory Pre-Routed and Pre-Loaded Optical Fiber Assemblies. Optical fiber assemblies pre-installed and routed at the factory to eliminate field-installed fiber routing and internal cable parking loops.
105—Standardized Fiber Groupings. Organized groupings of optical fibers in multiples of 12, 16, or 24 (or other standardized fiber groupings).
106—Sliding Connector Modules. Modules mounted within the distribution housing and movable between service and installed positions.
107—Service Position. A position of a sliding connector module allowing access for installation, removal, or maintenance of optical components.
108—Installed Position. A secured operational position of a sliding connector module during normal system operation.
109—Feeder Fibers. Incoming optical fibers supplying signals to the modular fiber optic connectivity system.
110—High-Density Splitter Module. An optical splitter supported by a sliding connector module and configured for signal distribution.
111—Multifiber Port. A port configured to simultaneously support pass-through optical signals and distribution outputs.
112—Pass-Through Optical Signals. Optical signals that traverse the system without being split or distributed.
113—Distribution Outputs. Optical signals output from the high-density splitter module for downstream distribution.
114—Incremental Expansion Architecture. The system configuration enabling expansion from a first operational capacity to a larger operational capacity without rerouting feeder fibers or replacing feeder cables.
115—Additional Sliding Connector Modules. Sliding connector modules selectively insertable to increase system capacity without disturbing installed modules.
116—Physically Separate Pass-Through Side. A portion of the distribution housing dedicated to pass-through fibers and physically separated from distribution fibers.
117—Craft Separation. Functional separation between feeder fibers and distribution fibers achieved by the physically separate pass-through side to simplify technician access and reduce interference.
118—Flood-Resistant Enclosure. A distribution housing configured to resist water ingress for below-grade installation.
119—Below-Grade Installation Configuration. A deployment configuration enabling subterranean placement of the modular fiber optic connectivity system.
120—Pole-Mounted Deployment Configuration. A configuration enabling attachment of the distribution housing to a pole.
121—Pedestal-Mounted Deployment Configuration. A configuration enabling ground-mounted deployment using a pedestal structure.
122—Low-Profile Multi-Fiber Connectors. Compact multi-fiber connectors supported by the sliding connector modules and accessible while adjacent sliding connector modules remain in an installed position.
123—Optical Terminations. Termination points of optical fibers within the system.
124—GR-Compliant Terminations. Optical terminations compliant with GR- 1209, GR-1221, and GR-1435 standards.
125—Operational Capacity Range. The supported operational capacity of the system ranging from approximately 72 connections to approximately 864 connections.
126—Modular Cassette Assembly. A modular cassette assembly receivable within the distribution housing and configured to support internal fiber management structures, connector interface regions, and replaceable optical subcomponents, enabling scalable capacity and serviceability.
126A—Cassette Cover. A removable cover forming a portion of the modular cassette assembly and configured to provide access to internal cassette components for installation, inspection, or maintenance.
126B—Cassette Housing. A structural base of the modular cassette assembly configured to support internal fiber management structures and connector interface regions.
126C—Internal Fiber Management Structures. One or more internal fiber routing, storage, or management features supported by the cassette housing and configured to guide and organize optical fibers within the modular cassette assembly.
126D—Internal Optical Module Supports. One or more internal support structures configured to retain optical functional modules, including splitter modules or rotating organizer elements, within the modular cassette assembly.
126E—Side Connector Interface Regions. Connector interface regions disposed along a side portion of the cassette housing and configured to support optical connectors for interfacing with feeder fibers, distribution fibers, or pass-through fibers.
126F—Top-Insertable Connector Modules. One or more removable or insertable connector modules receivable from a top portion of the cassette housing and configured to provide optical connectivity and modular capacity expansion within the modular cassette assembly.
127—Fiber Distribution Enclosure. A housing configured to receive, retain, and align a plurality of modular cassette assemblies and to manage incoming, outgoing, and pass-through optical fibers.
127A—External Enclosure Cover. An outer cover of the fiber distribution enclosure providing environmental protection.
127B—Internal Enclosure Cover. An internal cover positioned between the external enclosure cover and the modular cassette assemblies.
127C—Enclosure Pedestal Housing. A structural portion of the fiber distribution enclosure configured for wall, pole, pedestal, or other mounting.
127D—Enclosure Fiber Connectors. One or more connectors associated with the fiber distribution enclosure for terminating, routing, or coupling optical fibers.
127E—Enclosure Connector Mounting Plate. A mounting structure within the fiber distribution enclosure configured to support the enclosure fiber connectors.
127F—Enclosure Cover Stoppers or Retainers. One or more elements configured to limit, retain, or guide movement of the external or internal enclosure covers.

### DETAILED DESCRIPTION OF THE PREFERRED EMBODIMENT

The following description references the above-defined drawings and represents only an exemplary embodiment of the invention. It is foreseeable, and recognizable by those skilled in the art, that various modifications and/or substitutions to the invention could be implemented without departing from the scope and the character of the invention. Reference is also made to the attached Specification entitled “Fiber Optic Termination Enclosure with Visual Alignment Indicator for Connector Seating Verification” (hereinafter “Specification”), which includes the Background of the Invention, Summary of the Invention, Description of the Drawings, Figure Reference Numbers, Claims, and Abstract.

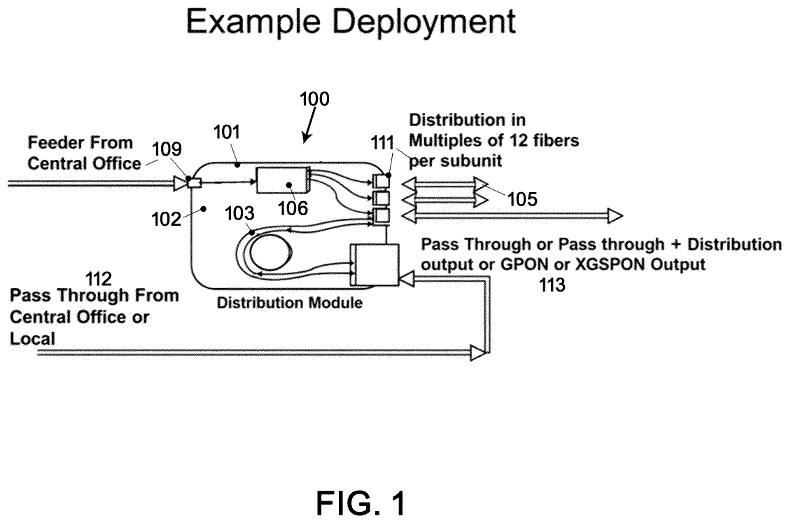

As shown in FIGS. 1-3, the invention provides a modular fiber optic connectivity system (100) including a distribution housing (101) defining a high-density fiber management interior (102). The distribution housing (101) functions as the primary structural platform for integrating high-density optical components, routing optical fibers, and supporting modular expansion while maintaining serviceability and internal organization.

In preferred embodiments, the high-density fiber management interior (102) contains factory pre-routed and pre-loaded optical fiber assemblies (103). The factory pre-routing preferably reduces or eliminates the need for field-installed slack management and cable parking loops by providing preconfigured internal routing paths and predetermined fiber lengths. As a result, field installation is simplified and the risk of disturbing existing connections during expansion or service is reduced.

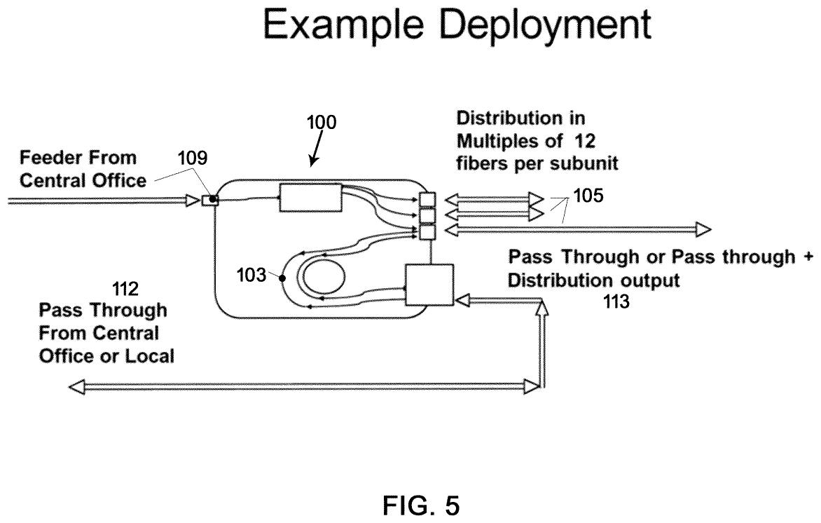

As further illustrated in FIGS. 1 and 5, the factory pre-routed and pre-loaded optical fiber assemblies (103) are organized into standardized fiber groupings (105). In preferred embodiments, the standardized groupings (105) include groupings of twelve (12), sixteen (16), or twenty-four (24) fibers, and may also include other standardized groupings consistent with industry practice. This standardized grouping structure enables predictable capacity planning and facilitates incremental scaling as additional modules and optical components are installed.

As shown in FIGS. 1-5, the distribution housing (101) supports a plurality of sliding connector modules (106). The sliding connector modules (106) are mounted within the distribution housing (101) such that each module is movable between a service position (107) and an installed position (108). In the service position (107), a selected module is positioned to provide improved access for installation, removal, replacement, testing, or maintenance of optical components. In the installed position (108), the module is retained in an operational position suitable for normal use while maintaining organization of fibers within the housing.

In preferred embodiments, the sliding connector modules (106) are configured such that a technician can place a selected module into the service position (107) without requiring removal or significant manipulation of adjacent modules that remain in their installed positions (108). This serviceability feature is especially advantageous in high-density environments, where internal access constraints and cable congestion typically increase the risk of accidental disconnections or fiber damage during maintenance.

As shown in FIGS. 1-4, the modular architecture supports optical distribution through one or more high-density splitter modules (110). A splitter module (110) is supported by, mounted to, or otherwise associated with a sliding connector module (106). In certain embodiments, the splitter module (110) receives incoming optical signals and generates multiple outputs for downstream distribution. The splitter module (110) can be installed, removed, replaced, or serviced in connection with movement of the associated sliding connector module (106) into the service position (107).

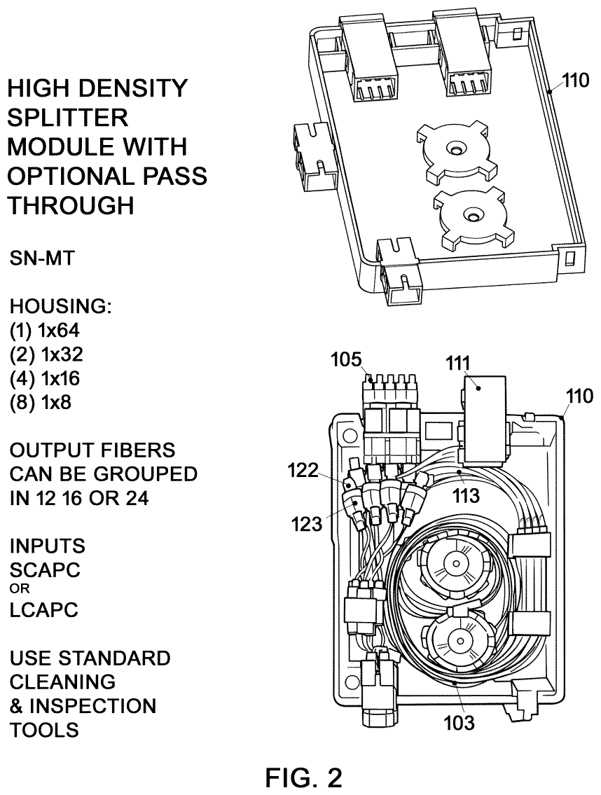

In preferred implementations shown in FIGS. 2-4, optical connectivity is provided through compact interface structures including low-profile multi-fiber connectors (122) and optical terminations (123). The low-profile connector configuration facilitates higher connector density and improved access in limited internal space, while the optical terminations (123) provide controlled termination locations for optical fiber endpoints and component interfaces.

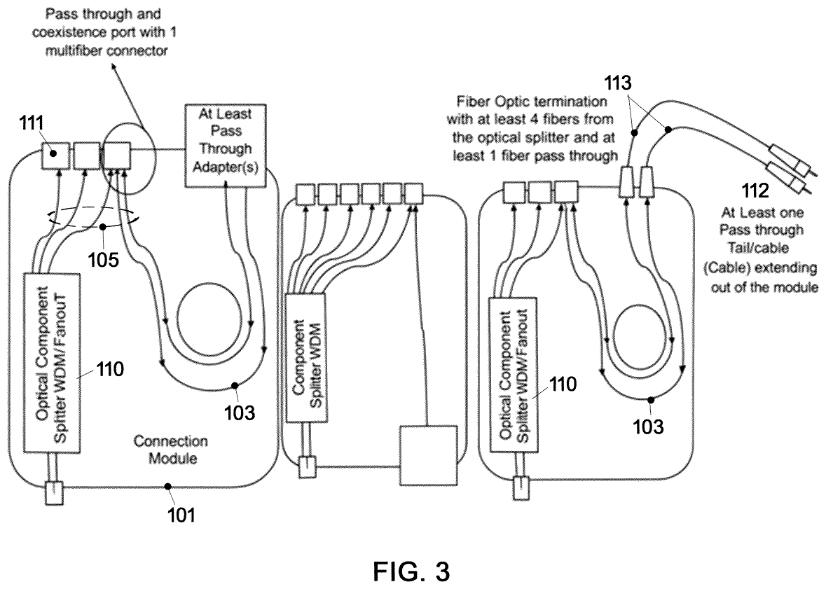

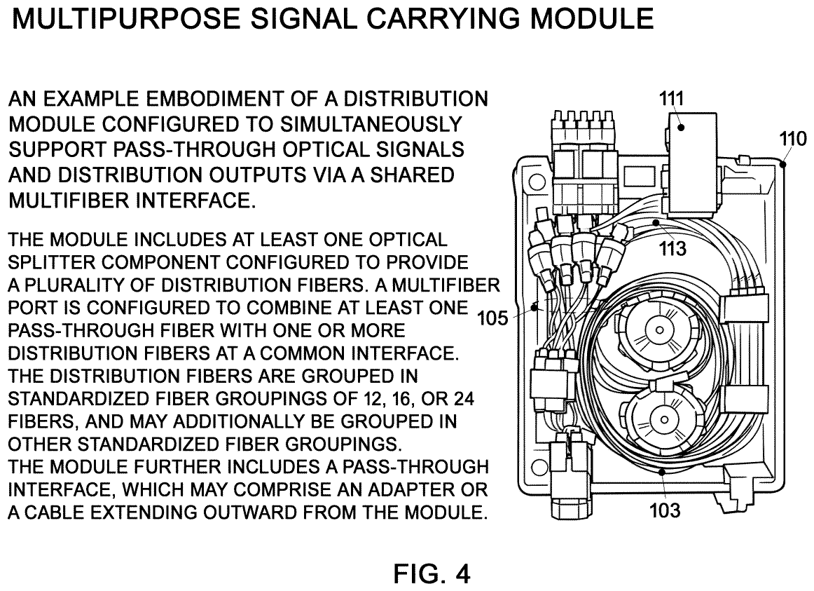

As shown in FIGS. 3 and 4, the invention further includes at least one multifiber port (111) configured to support both pass-through and distribution functionality at a common interface. In preferred embodiments, the multifiber port (111) is configured to combine at least one pass-through optical signal path (112) with one or more distribution outputs (113). This integrated interface enables coexistence of pass-through and distribution optical signals within the same modular architecture.

As illustrated by the signal flow representations in FIGS. 1, 3, and 5, pass-through optical signals (112) are configured to traverse the system without being split or distributed, while distribution outputs (113) are provided as downstream distribution fibers resulting from optical splitting at the splitter module (110). The multifiber port (111) therefore supports a combined interface architecture in which pass-through and distribution functions can be implemented without requiring separate and duplicative platforms.

As shown in FIG. 4, the distribution outputs (113) may be organized as standardized fiber groupings (105), including groupings of twelve, sixteen, or twenty-four fibers, thereby maintaining consistent scaling across modules and deployments. In preferred embodiments, the modular architecture supports combined pass-through and distribution routing while maintaining internal organization of the factory pre-routed fiber assemblies (103).

Incremental scaling is achieved through an incremental expansion architecture (114), as illustrated in FIGS. 1 and 5, in which capacity may be increased by selectively inserting additional sliding connector modules (115) without replacement of feeder cables and without redistribution of installed fibers. In preferred embodiments, the system can be initially deployed at a lower operational capacity and later expanded by adding additional modules and optical distribution components, thereby reducing up-front installation burden while enabling long-term scalability.

In certain embodiments, the system supports an operational capacity range (125) extending from approximately seventy-two (72) connections to approximately eight hundred sixty-four (864) connections. The capacity range (125) is achieved through the modular architecture, standardized fiber grouping structure (105), and selective addition of modules and optical distribution components within the distribution housing (101).

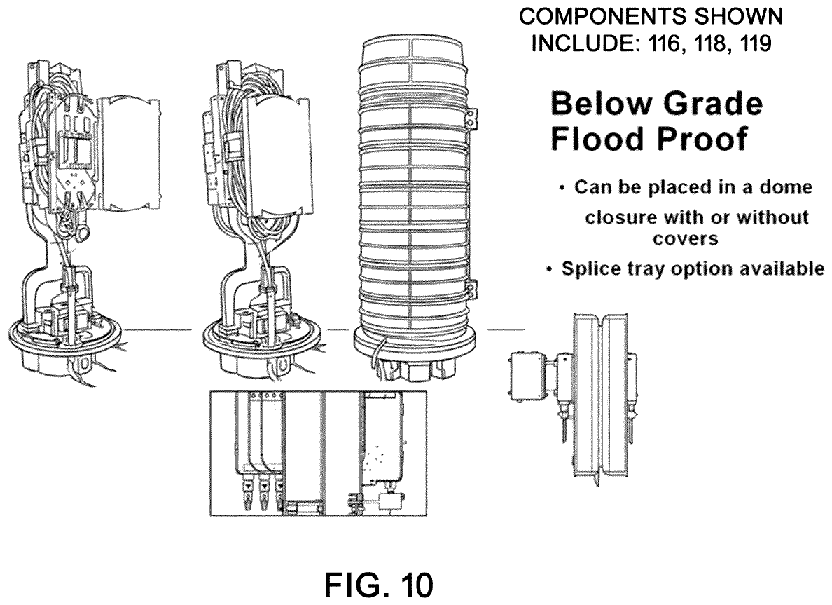

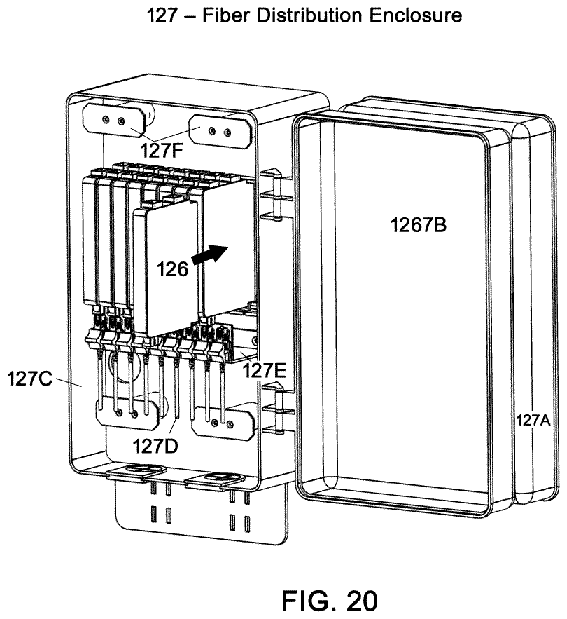

As shown in FIGS. 10 and 20, the system may include a physically separate pass-through side (116) configured to provide craft separation (117) between feeder fibers and distribution fibers. In preferred embodiments, the physically separate pass-through side (116) is a dedicated region or channel within the overall system architecture, separating pass-through handling from distribution handling, which can reduce fiber congestion and simplify technician workflows during installation and service operations.

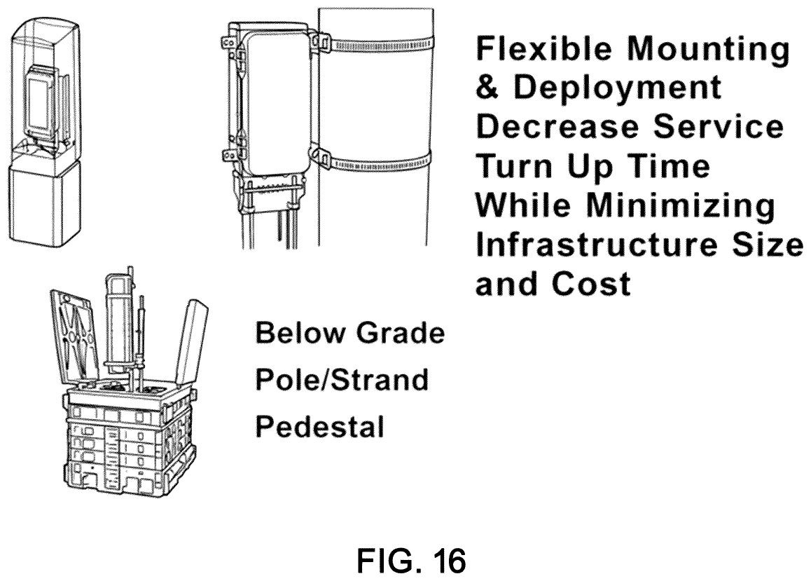

In preferred below-grade embodiments, the distribution housing (101) and/or enclosure architecture may include a flood-resistant enclosure (118) suitable for below-grade installation (119), as illustrated in FIGS. 10 and 16. The flood-resistant enclosure (118) preferably provides improved environmental protection against moisture exposure and other below-grade conditions. The below-grade installation configuration (119) enables deployment in subterranean or semi-subterranean environments while maintaining accessibility to serviceable modules and optical interfaces.

Alternative deployment configurations are illustrated in FIG. 16, including pole-mounted deployment (120) and pedestal-mounted deployment (121). In preferred embodiments, these deployment configurations may be implemented without modification to the internal modular architecture, allowing the same core system components to be used across multiple installation environments.

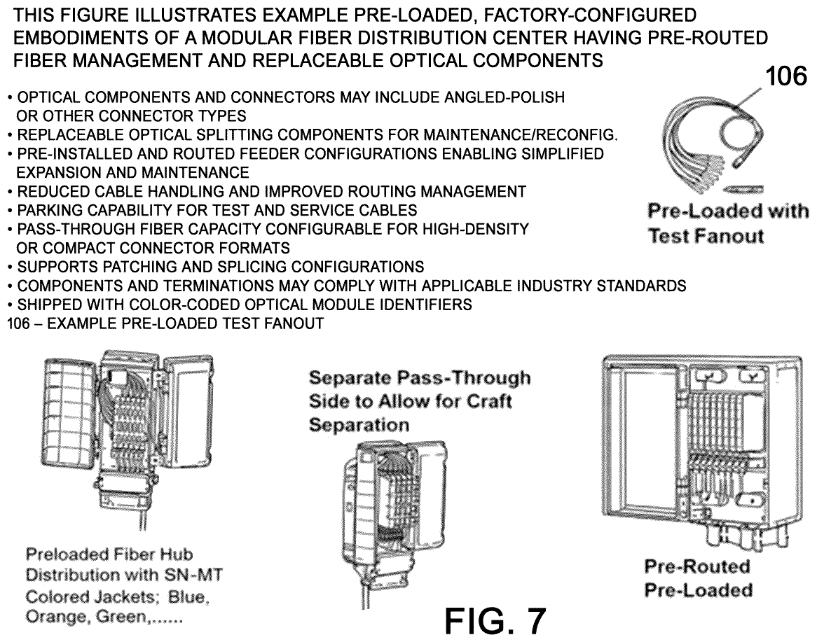

As shown in FIG. 7, preferred embodiments may be provided as factory-configured and pre-loaded assemblies. For example, FIG. 7 depicts embodiments described as “pre-loaded” and configured to support simplified installation and servicing. Such embodiments are consistent with the factory pre-routed and pre-loaded optical fiber assemblies (103) and modular architecture described herein.

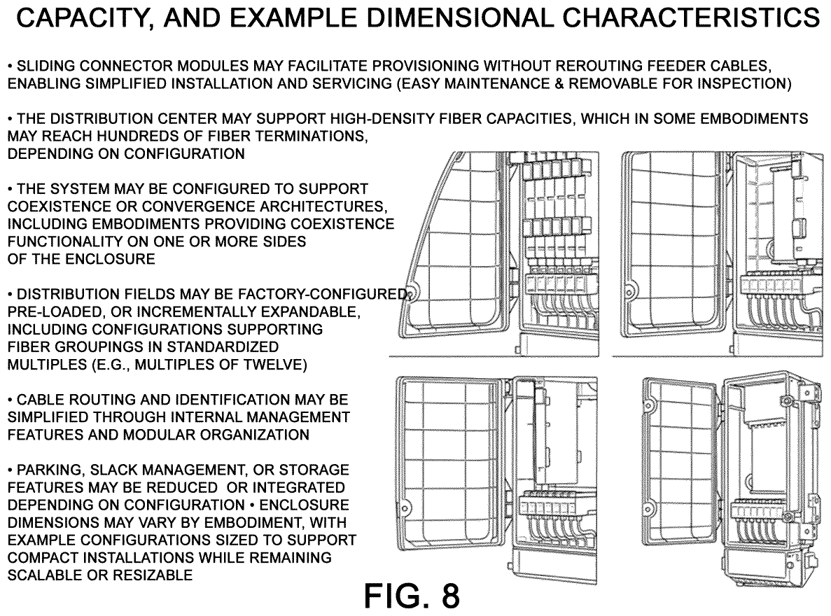

As shown in FIG. 8, preferred embodiments may also support scalable deployment planning and incremental growth, including capacity planning and modular scaling concepts. While FIG. 8 may present capacity and configuration concepts at a high level, such concepts align with the incremental expansion architecture (114) and selective insertion of additional sliding connector modules (115).

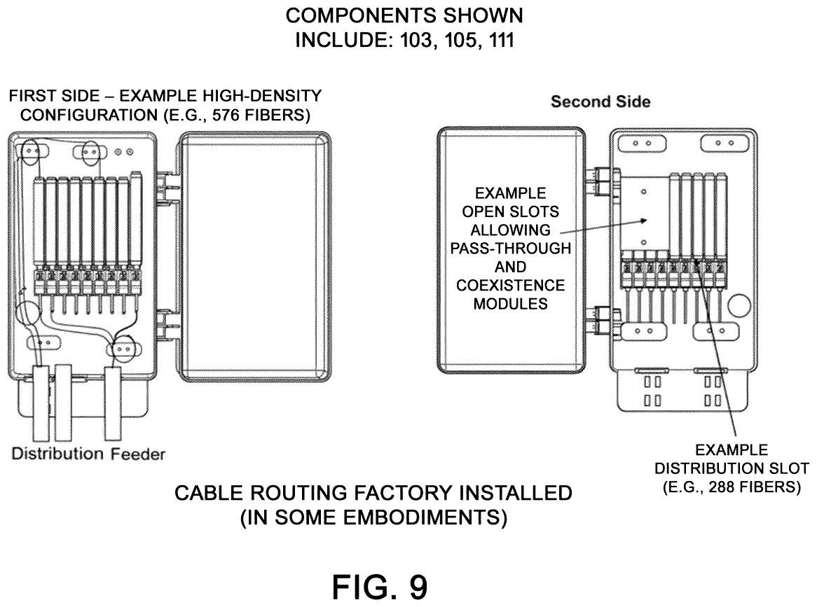

As illustrated in FIG. 9, internal component arrangements may include fiber routing elements and interface structures associated with the factory pre-routed assemblies (103), standardized fiber groupings (105), and multifiber port configurations (111). FIG. 9 illustrates representative internal layouts supporting organized routing and stable connector interface positioning.

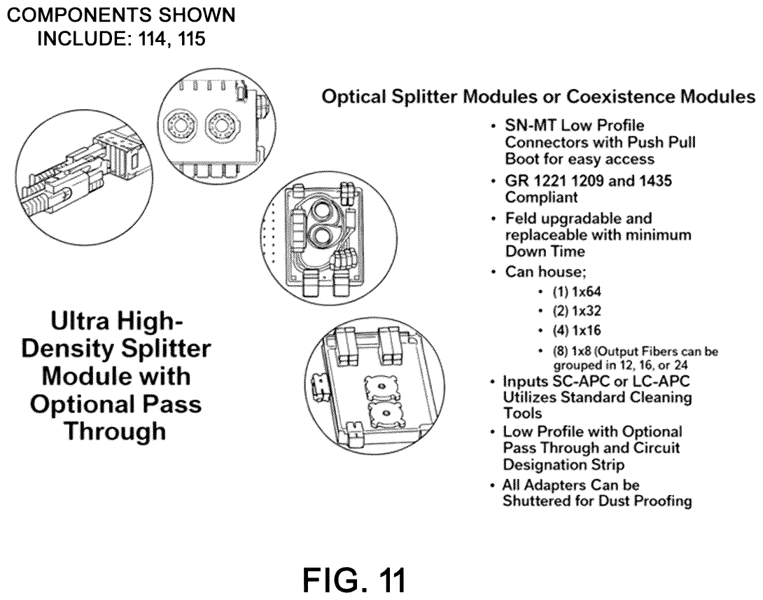

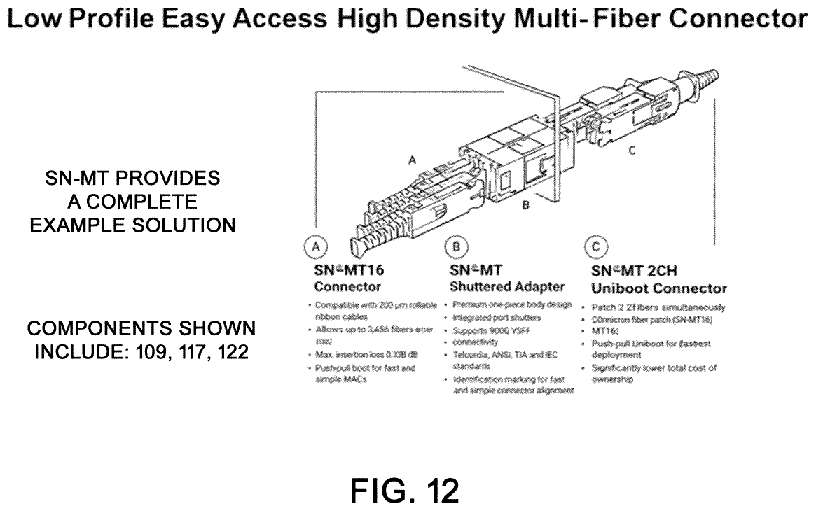

As shown in FIGS. 11 and 12, preferred embodiments can include high-density connector and splitter configurations suitable for modern high-density fiber optic deployments. FIG. 11 illustrates an example high-density splitter configuration consistent with the splitter module (110). FIG. 12 illustrates example multifiber connector arrangements consistent with compact connector architectures, including low-profile connector structures (122) and termination configurations (123), as applicable.

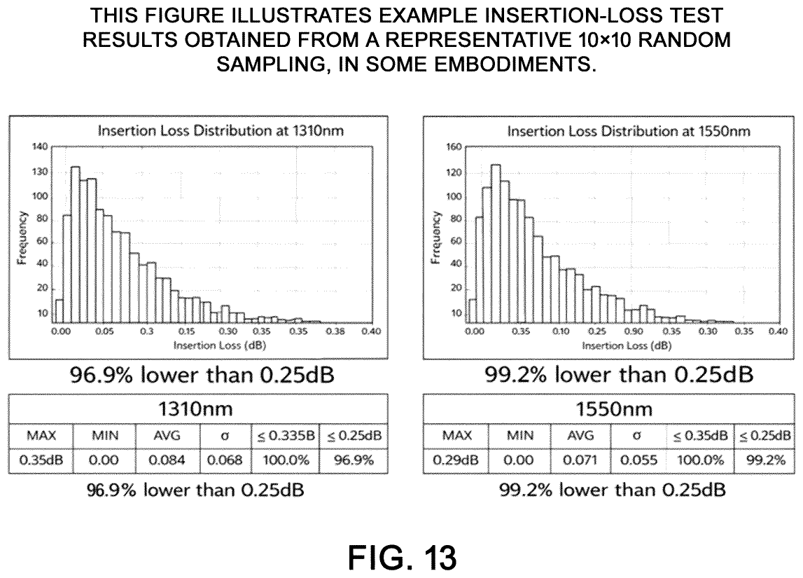

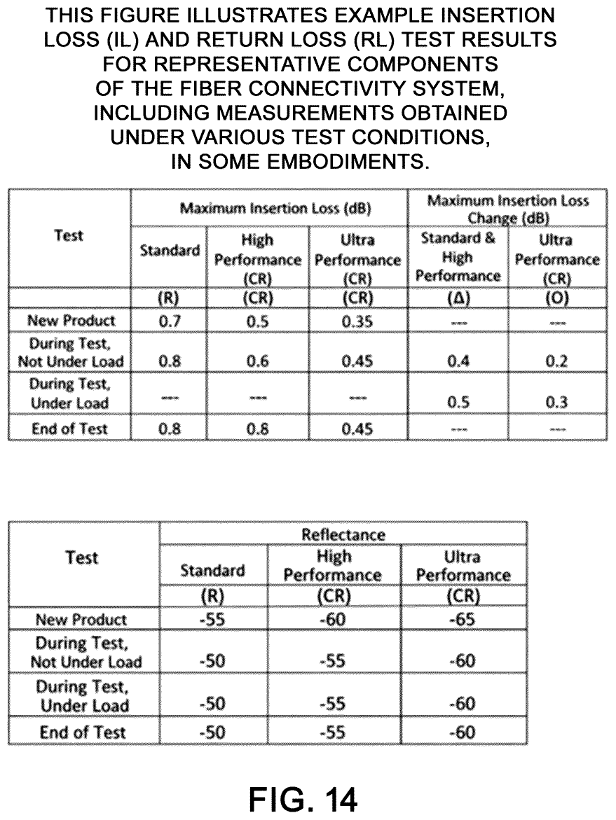

As shown in FIGS. 13 and 14, preferred embodiments may be characterized by performance results and test data associated with insertion loss and return loss for components used within the system architecture. The results shown in FIGS. 13 and 14 may correspond to optical performance characteristics achievable using the modular interfaces, connector configurations, and routing structures described herein, without requiring field-installed parking loops or extensive rerouting during expansion.

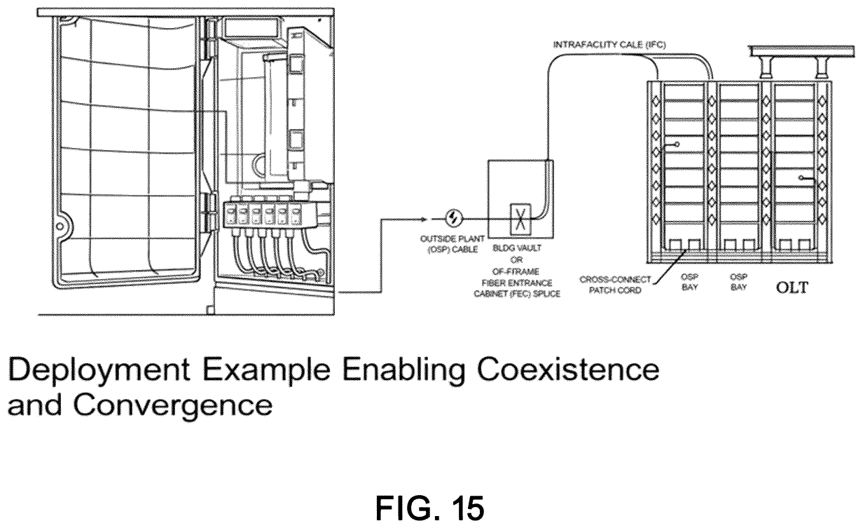

As shown in FIG. 15, preferred deployments may include coexistence of multiple optical functions within a unified architecture, consistent with simultaneous support of pass-through optical signals (112) and distribution outputs (113) at a common interface (111), and with modular distribution via splitter modules (110).

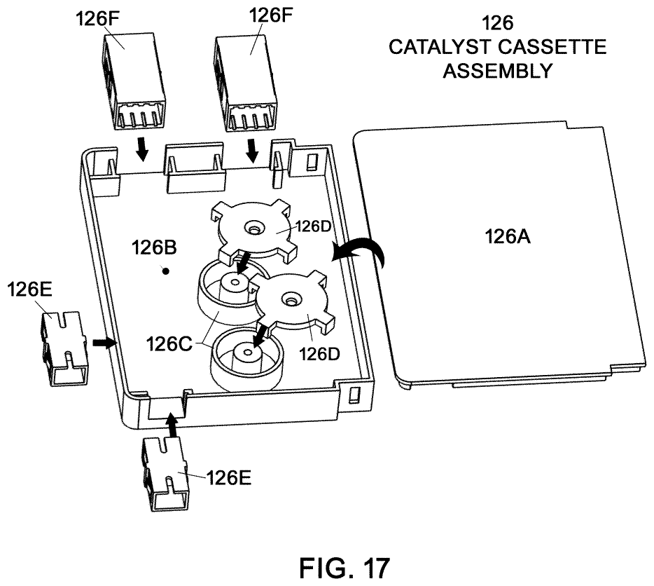

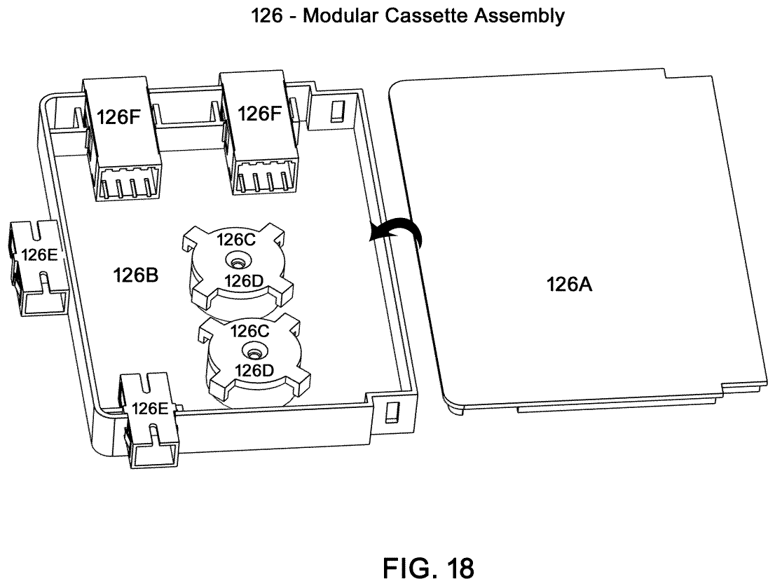

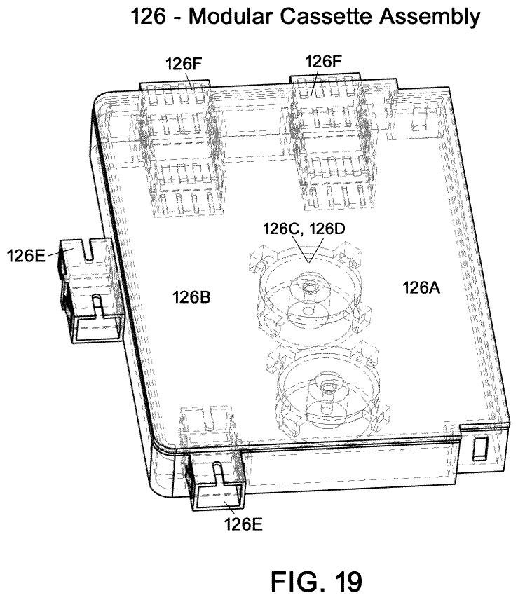

As shown in FIGS. 17-19, preferred embodiments include a modular cassette assembly (126) configured to be receivable within a supporting system architecture. The modular cassette assembly (126) includes a cassette cover (126A) and a cassette housing (126B). In preferred embodiments, the cassette cover (126A) is removable to permit inspection, access, and servicing of internal components.

In the preferred embodiments shown in FIGS. 17-19, the modular cassette assembly (126) further includes internal fiber management structures (126C) configured to guide and organize fibers within the cassette while maintaining appropriate bend radius and orderly routing paths. In certain implementations, the internal fiber management structures (126C) include spool-like routing features and retention structures that constrain fiber movement while enabling organized storage and routing.

The modular cassette assembly (126) may further include internal optical module supports (126D) configured to retain optical functional modules within the cassette assembly. In preferred embodiments, the internal optical module supports (126D) support module positioning, retain optical components against movement, and facilitate modular replacement of optical subcomponents.

As further shown in FIGS. 17-19, the modular cassette assembly (126) includes side connector interface regions (126E) configured to support optical connector interfaces along side portions of the cassette housing (126B). The cassette assembly may also include top-insertable connector modules (126F), enabling modular insertion and removal of connector modules to expand capacity or support differing interface configurations.

As shown in FIG. 20, preferred embodiments may further include a fiber distribution enclosure (127) configured to receive, align, and retain one or more modular cassette assemblies (126). The fiber distribution enclosure (127) provides an enclosure-level platform for managing incoming fibers, outgoing fibers, and pass-through optical paths while supporting modular cassette insertion and alignment.

In preferred embodiments shown in FIG. 20, the fiber distribution enclosure (127) includes an external enclosure cover (127A) configured to provide environmental protection, and an internal enclosure cover (127B) configured to provide internal separation and component protection. The enclosure may further include an enclosure pedestal housing (127C) configured for mounting and structural support.

As further illustrated in FIG. 20, the fiber distribution enclosure (127) may include enclosure fiber connectors (127D) supported by a connector mounting plate (127E). The connector mounting plate (127E) provides a structural interface for retaining connectors in fixed positions to facilitate consistent fiber termination and routing. In addition, the enclosure may include cover stoppers or retainers (127F) configured to limit, guide, or retain movement of the external cover (127A) and/or internal cover (127B), thereby supporting repeatable opening and closing operations.

Through the combination of the distribution housing (101) and high-density fiber management interior (102), the factory pre-routed optical fiber assemblies (103), the sliding connector modules (106) movable between service and installed positions (107, 108), the splitter module architecture (110), the combined pass-through and distribution interface (111-113), the incremental expansion architecture (114-115), and the modular cassette and enclosure embodiments (126-127F), the invention provides a compact, scalable, and serviceable fiber optic connectivity solution suitable for modern high-density optical networks.

Although preferred embodiments have been described with reference to specific figures and reference numerals, it will be understood that the invention is not limited to the illustrated embodiments, and that variations may be made in structure, arrangement, and operation without departing from the scope of the claims.

In use, installation of the modular fiber optic connectivity system (100) begins with mounting the distribution housing (101) or fiber distribution enclosure (127) at a desired installation location, such as a wall-mounted, pedestal-mounted, pole-mounted, or below-grade location, as illustrated in FIGS. 10, 16, and 20. Once mounted, incoming feeder fibers (109) are routed into the enclosure through designated entry locations and organized within the high-density fiber management interior (102) using the factory pre-routed optical fiber assemblies (103).

As shown in FIGS. 1, 5, and 20, modular cassette assemblies (126) may be sequentially inserted into the fiber distribution enclosure (127). Each cassette assembly (126) is guided into alignment by structural features of the enclosure pedestal housing (127C), which positions the cassette assemblies in a stacked or side-by-side arrangement. This alignment ensures consistent engagement of side connector interface regions (126E) with enclosure fiber connectors (127D) mounted on the connector mounting plate (127E).

During cassette insertion, the cassette cover (126A) may remain installed to protect internal components. In certain service or configuration scenarios, the cassette cover (126A) may be removed, as illustrated in FIGS. 17-19, to provide access to internal fiber management structures (126C) and internal optical module supports (126D). This allows a technician to inspect, route, or replace internal optical components while the cassette assembly (126) is removed from or partially inserted into the enclosure (127).

As shown in FIGS. 17-19, internal fiber management structures (126C) guide optical fibers along predefined routing paths within the cassette assembly (126), maintaining controlled bend radii and preventing fiber crossover or congestion. Fibers are retained by internal optical module supports (126D), which stabilize splitter modules, connector modules, or other optical subcomponents during handling and operation.

Once installed within the enclosure (127), individual optical distribution and pass-through functions are accessed through the sliding connector modules (106), as shown in FIGS. 1-4. To perform installation, testing, or maintenance, a technician selectively moves a sliding connector module (106) from the installed position (108) to the service position (107). This movement provides forward access to the associated splitter module (110), multifiber port (111), and optical connectors without disturbing adjacent modules that remain in their installed positions.

As illustrated in FIG. 4, the multifiber port (111) enables simultaneous handling of pass-through optical signals (112) and distribution outputs (113). In use, pass-through fibers are routed through the port (111) without being split, while selected fibers are routed to the splitter module (110) to generate standardized distribution outputs grouped according to standardized fiber groupings (105). This configuration allows coexistence of feeder continuation and local distribution within the same physical module.

Incremental expansion of system capacity is accomplished by inserting additional sliding connector modules (115) or additional cassette assemblies (126), as illustrated in FIGS. 1, 5, and 20. Expansion may occur without rerouting existing feeder fibers (109) and without redistributing installed fibers, as the factory pre-routed fiber assemblies (103) and standardized fiber groupings (105) provide predefined pathways for additional connections.

In below-grade deployments shown in FIGS. 10 and 16, the flood-resistant enclosure (118) and below-grade installation configuration (119) protect internal components from moisture and environmental exposure. Access to serviceable components is maintained by removable enclosure covers (127A, 127B) and by the ability to withdraw sliding connector modules (106) to the service position (107) without opening or disturbing internal fiber routing.

In embodiments including a physically separate pass-through side (116), as shown in FIGS. 10 and 20, feeder fibers and pass-through fibers are routed through a dedicated region of the enclosure that is physically separated from distribution fibers. This craft separation (117) allows technicians to service pass-through fibers independently from distribution operations, reducing congestion and minimizing the risk of accidental interference with active distribution connections.

As illustrated in FIG. 7, factory-configured and pre-loaded embodiments may be delivered with selected splitter modules (110), connector configurations (122), and fiber routing already installed. Such pre-loaded embodiments enable rapid field deployment by reducing on-site assembly steps and ensuring consistent internal organization.

Performance characteristics associated with the system architecture are illustrated in FIGS. 13 and 14, which show representative insertion loss and return loss results for connector and splitter configurations used within the system. These performance results demonstrate that high-density modular configurations can be achieved while maintaining acceptable optical performance, even as capacity is incrementally expanded.

Through the combined use of modular cassette assemblies (126), sliding connector modules (106), factory pre-routed fiber assemblies (103), and enclosure-based alignment and retention features (127C-127F), the system supports efficient installation, servicing, testing, and expansion throughout its operational life, without requiring disruptive reconfiguration of existing fiber connections.

We claim:

1. A modular fiber optic connectivity system, comprising:
(A) a distribution housing defining a high-density fiber management interior;
(B) a plurality of factory pre-routed and pre-loaded optical fiber assemblies disposed within the distribution housing, the optical fiber assemblies being organized in standardized groupings of 12, 16, or 24 fibers;
(C) a plurality of sliding connector modules mounted within the distribution housing, each sliding connector module being movable between a service position and an installed position and being configured to permit installation, removal, or replacement of optical components without rerouting feeder fibers;
(D) at least one high-density splitter module supported by at least one of the sliding connector modules;
(E) at least one multifiber port configured to simultaneously support (i) pass-through optical signals and (ii) distribution outputs from the high-density splitter module; and
(F) wherein the distribution housing is configured to support incremental expansion from a first operational capacity to a larger operational capacity without replacement of feeder cables or redistribution of installed fibers.

2. The system of claim 1, wherein the sliding connector modules are configured to support splitter configurations selected from the group consisting of 1×64, 1×32, 1×16, and 1×8.

3. The system of claim 1, wherein the sliding connector modules include low-profile multi-fiber connectors that remain accessible while adjacent sliding connector modules remain in an installed position.

4. The system of claim 1, wherein the distribution housing includes a physically separate pass-through side configured to maintain craft separation between feeder fibers and distribution fibers.

5. The system of claim 1, wherein the factory pre-routed optical fiber assemblies eliminate internal cable parking loops and field-installed fiber routing.

6. The system of claim 1, wherein the distribution housing comprises a flood-resistant enclosure configured for below-grade installation while maintaining service access to the sliding connector modules.

7. The system of claim 6, wherein the distribution housing is alternatively configurable for pole-mounted or pedestal-mounted deployment without modification to the internal fiber architecture.

8. The system of claim 1, wherein incremental expansion is achieved by selective insertion of additional sliding connector modules without disturbing installed sliding connector modules.

9. The system of claim 1, wherein the system supports a total operational capacity ranging from approximately 72 connections to approximately 864 connections.

10. The system of claim 1, wherein optical terminations comply with GR-1209, GR-1221, and GR-1435 standards.

11. A modular fiber optic connectivity system, comprising:
(A) a distribution housing defining a high-density fiber management interior;
(B) at least one modular cassette assembly receivable within the distribution housing, the modular cassette assembly comprising:
(a) a cassette housing;
(b) internal fiber management structures supported by the cassette housing; and
(c) one or more connector interface regions configured to support optical connectivity;
(C) a plurality of factory pre-routed and pre-loaded optical fiber assemblies disposed within at least one of the distribution housing and the modular cassette assembly, the optical fiber assemblies being organized in standardized groupings of 12, 16, or 24 fibers;
(D) a plurality of sliding connector modules supported by the modular cassette assembly and mounted within the distribution housing, each sliding connector module being movable between a service position and an installed position to permit installation, removal, or replacement of optical components without rerouting feeder fibers;
(E) at least one high-density splitter module supported by at least one of the sliding connector modules; and
(F) at least one multifiber port configured to simultaneously support (i) pass-through optical signals and (ii) distribution outputs from the high-density splitter module;
(G) wherein the modular cassette assembly enables incremental expansion from a first operational capacity to a larger operational capacity without replacement of feeder cables or redistribution of installed fibers.

12. The system of claim 11, wherein the modular cassette assembly further comprises a removable cassette cover configured to provide access to internal cassette components.

13. The system of claim 11, wherein the cassette housing comprises a structural base configured to support internal fiber management structures and connector interfaces.

14. The system of claim 11, wherein the internal fiber management structures comprise one or more routing guides, storage features, or organizers configured to manage fiber routing and bend radius.

15. The system of claim 11, wherein the modular cassette assembly further comprises one or more internal optical module supports configured to retain splitter modules or rotating organizer elements.

16. The system of claim 11, wherein the cassette housing includes side connector interface regions configured to support optical connectors for feeder fibers, distribution fibers, or pass-through fibers.

17. The system of claim 11, wherein the modular cassette assembly includes one or more top-insertable connector modules receivable from a top portion of the cassette housing to provide modular optical connectivity and scalable capacity expansion.

18. A method of managing high-density fiber optic connectivity, comprising:
(A) providing a modular fiber distribution system having factory pre-routed optical fibers arranged in standardized groupings;
(B) installing optical components into sliding connector modules that are movable within the modular fiber distribution system;
(C) performing maintenance, replacement, or expansion of the optical components by moving the sliding connector modules without rerouting feeder fibers; and
(D) incrementally expanding system capacity by inserting additional sliding connector modules while maintaining uninterrupted service to existing connections.

19. The method of claim 18, further comprising deploying the modular fiber distribution system in a below-grade flood-resistant enclosure.

20. The method of claim 18, further comprising physically separating feeder fibers and distribution fibers on opposite sides of the modular fiber distribution system.
